(19) United States
(12) Patent Application Publication
(10) Pub. No.: US 2022/0238885 A1
(43) Pub. Date: Jul. 28, 2022

(54) CARBON-BASED CONDUCTIVE FILLER PRECURSOR DISPERSIONS FOR BATTERY ELECTRODES AND METHODS FOR MAKING AND USE THEREOF

(71) Applicant: GM GLOBAL TECHNOLOGY OPERATIONS LLC, Detroit, MI (US)

(72) Inventors: Roland J. KOESTNER, Rochester Hills, MI (US); Anita LUONG, Ann Arbor, MI (US); Xiaosong HUANG, Novi, MI (US)

(73) Assignee: GM GLOBAL TECHNOLOGY OPERATIONS LLC, Detroit, MI (US)

(21) Appl. No.: 17/159,978

(22) Filed: Jan. 27, 2021

(51) Int. Cl. H01M 4/62; H01M 4/04

(52) U.S. Cl. CPC H01M 4/625; H01M 4/622; H01M 4/0404

(57) ABSTRACT

An electrode conductive filler precursor dispersion is provided that includes a conductive carbon-based particle selected from the group consisting of: graphene nanoplatelet (GNP), carbon nanofibers (CNF), carbon nanotubes (CNT), and combinations thereof. A stabilizing polymer comprising polyvinyl-4-pyridine (PVPy). The dispersion also includes a solvent. The electrode conductive filler precursor dispersion is substantially free of syneresis for greater than or equal to about 7 days. Methods of making the electrode conductive filler precursor dispersion and electrodes from the electrode conductive filler precursor dispersion are also provided.

### INTRODUCTION

This section provides background information related to the present disclosure which is not necessarily prior art.

The present disclosure relates to a stable electrode conductive filler precursor dispersion including carbon-based nanoparticles that are evenly distributed, stable, and capable of being used to form electrodes having improved electrochemical performance.

Conductive carbon-based fillers may be added to both negative (anode) and positive (cathode) electrodes of electrochemical cells, such as lithium ion batteries (LIB) that can be used in a variety of consumer products and vehicles, such as Hybrid Electric Vehicles (HEVs) and Electric Vehicles (EVs). These conductive carbon fillers serve to improve electrical performance, for example, to reduce internal electronic resistance within the electrode. However, these carbon-based additives have a much higher surface area than the electroactive material particles and are more challenging to uniformly disperse in the electrode slurry during electrode formation.

Moreover, in addition to high surface area, certain carbon-based conductive additives, like graphene nanoplatelets (GNP), carbon nanofibers (CNF), carbon nanotubes (CNT) have a high aspect ratio. Generally, an aspect ratio (AR) may be defined as AR=L/W where L is the length of the longest axis and W is the width of the particle. Exemplary high aspect ratios may range from about 100 to about 5,000 or greater. Such high aspect ratio particles further increase the difficulty in creating a homogeneous distribution in an electrode that is formed. The difficulty in creating an even or homogeneous dispersion of the carbon-based high aspect ratio particles arises first in effectively debundling the physical agglomerates present in the incoming powders and second in reaching adequate colloidal stability for a solvent-based dispersion that avoids re-agglomeration of the particles.

Enhanced uniformity in dispersing these carbon-based fillers promotes optimal electrochemical performance for an electrode. It is desirable to develop methods of making electrodes that minimize agglomeration, to achieve even distribution of carbon-based conductive particles in the formed electrodes, and to develop stable dispersions of such carbon-based conductive particles as electrode precursors.

### SUMMARY

This section provides a general summary of the disclosure, and is not a comprehensive disclosure of its full scope or all of its features.

In certain aspects, the present disclosure relates to an electrode conductive filler precursor dispersion including a conductive carbon-based particle selected from the group consisting of: graphene nanoplatelet (GNP), carbon nanofibers (CNF), carbon nanotubes (CNT), or combinations thereof. The precursor dispersion also includes a stabilizing polymer including polyvinyl-4-pyridine (PVPy) and a solvent. The electrode conductive filler precursor dispersion is substantially free of syneresis for greater than or equal to about 7 days.

In one aspect, the solvent includes N-methyl-2-pyrrolidone (NMP).

In one aspect, the conductive carbon-based particle is present at greater than or equal to about 1 weight % to less than or equal to about 15 weight % of the electrode conductive filler precursor dispersion.

In one aspect, the conductive carbon-based particle includes:

graphene nanoplatelet (GNP) at greater than or equal to about 1 weight % to less than or equal to about 15% weight % of the electrode conductive filler precursor dispersion;

carbon nanofibers (CNF) at greater than or equal to about 1 weight % to less than or equal to about 12% weight % of the electrode conductive filler precursor dispersion; or

carbon nanotubes (CNT) at greater than or equal to about 1 weight % to less than or equal to about 5% weight % of the electrode conductive filler precursor dispersion.

In one aspect, the conductive carbon-based particle is present at greater than or equal to about 3 weight % to less than or equal to about 20 weight % of the electrode conductive filler precursor dispersion. The solvent is present at greater than or equal to about 70 weight % to less than or equal to about 97 weight % of the electrode conductive filler precursor dispersion. The stabilizing polymer is present at greater than or equal to about 1 weight % to less than or equal to about 8 weight % of the electrode conductive filler precursor dispersion.

In one aspect, the stabilizing polymer is present at greater than or equal to about 3 mg/m² to less than or equal to about 5 mg/m² loading relative to a surface area of the conductive carbon-based particle.

In one aspect, the stabilizing polymer is present at greater than or equal to about 3 weight % to less than or equal to about 5 weight % of the electrode conductive filler precursor dispersion.

In one aspect, the electrode precursor dispersion is shelf stable for greater than or equal to about 30 days.

In certain other aspects, the present disclosure relates to a method of making an electrode conductive filler precursor dispersion that includes mixing conductive carbon-based particles in a liquid at a high shear rate for debundling. The conductive carbon-based particles are selected from the group consisting of: graphene nanoplatelet (GNP), carbon nanofibers (CNF), carbon nanotubes (CNT), and combinations thereof. The method further includes introducing a stabilizing polymer including polyvinyl-4-pyridine (PVPy) and a solvent into the conductive carbon-based particles to form the electrode conductive filler precursor. The electrode conductive filler dispersion is substantially free of syneresis for greater than or equal to about 7 days.

In one aspect, a solids content during the mixing is greater than or equal to about 20 weight % solids to less than or equal to about 60 weight % solids.

In one aspect, the mixing is substantially free of grinding or milling media.

In one aspect, the stabilizing polymer is added at greater than or equal to about 3 mg/m² to less than or equal to about 5 mg/m² loading relative to a surface area of the conductive carbon-based particle to suppress reagglomeration.

In one aspect, the stabilizing polymer is present at greater than or equal to about 1 weight % to less than or equal to about 8 weight % of the electrode conductive filler precursor dispersion.

In one aspect, the conductive carbon-based particles includes:

graphene nanoplatelet (GNP) at greater than or equal to about 1 weight % to less than or equal to about 15% weight % of the electrode conductive filler precursor dispersion;

carbon nanofibers (CNF) at greater than or equal to about 1 weight % to less than or equal to about 12% weight % of the electrode conductive filler precursor dispersion; or

carbon nanotubes (CNT) at greater than or equal to about 1 weight % to less than or equal to about 5% weight % of the electrode conductive filler precursor dispersion.

In yet other aspects, the present disclosure relates to a method of making an electrode including mixing an electrode conductive filler precursor dispersion with a binder and electroactive material particles to form a slurry. The electrode conductive filler precursor dispersion includes a conductive carbon-based particle selected from the group consisting of: graphene nanoplatelet (GNP), carbon nanofibers (CNF), carbon nanotubes (CNT), and combinations thereof, a stabilizing polymer including polyvinyl-4-pyridine (PVPy), and a solvent. The method further includes applying the slurry to a current collector and drying the slurry to form an electrode active layer disposed on the current collector.

In one aspect, the method further includes consolidating the electrode active layer and current collector.

In one aspect, a dried electrode active layer includes greater than or equal to about 0.1 weight % to less than or equal to about 15 weight % of the conductive carbon-based particle, greater than or equal to about 50 weight % to less than or equal to about 99 weight % of the electroactive material particles, and greater than or equal to about 0.5 weight % to less than or equal to about 15 weight % of a total amount of polymer including the binder and stabilizing polymer.

In one aspect, the electroactive material particles include silicon.

In one aspect, the conductive carbon-based particle is evenly distributed in the electrode.

In one aspect, the slurry includes the conductive carbon-based particle at greater than or equal to about 5 weight % to less than or equal to about 25 weight %, the electroactive material particles at greater than or equal to about 50 weight % to less than or equal to about 80 weight %, the solvent at greater than or equal to about 1 weight % to less than or equal to about 5 weight %, and a total amount of binder and stabilizing polymer at greater than or equal to about 5 weight % to less than or equal to about 15 weight %.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example of an electrochemical battery cell for cycling lithium ions.

FIG. 2 shows hysteresis of a shear-thinning profile for a comparative dispersion of single wall carbon nanotubes in N-methyl-2-pyrrolidone (NMP) solvent without any stabilizing polymer.

FIG. 3 shows hysteresis of a shear-thinning profile for a dispersion of single wall carbon nanotubes in an NMP solvent with a stabilizing polymer in the form of aromatic polyvinyl-4-pyridine (PVPy) prepared in accordance with certain aspects of the present disclosure.

FIG. 4 is a bar chart of viscosity hysteresis in shear-thinning rheology for various 0.3% w/w single wall nanotube (SWNT) dispersions in NMP solvent.

FIG. 5 is a bar chart summarizing carbon pore volume reduction after milling.

FIG. 6 shows milling intensity for various carbon-based particles monitored by viscous heating of each stock carbon dispersion.

FIG. 7 shows particle size distribution (PSD) of debundled carbon nanofiber (CNF) agglomerates with higher dispersion of solids in an NMP solvent.

FIG. 8 shows a comparison of shear-thinning rheology comparing a graphene nanoplatelet (GNP) at 15% and commercial single wall carbon nanotubes at 0.4% in NMP solvent.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure provides precursors for making improved electrodes for high-performance lithium ion electrochemical cells (e.g., lithium ion batteries) and methods of making the precursors and improved electrodes for an electrochemical cell, which can address the above-described challenges with even distribution of carbon-based high-aspect ratio particles. The present technology in pertains to forming improved electrochemical cells, especially lithium-ion batteries. In various instances, such batteries are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example.

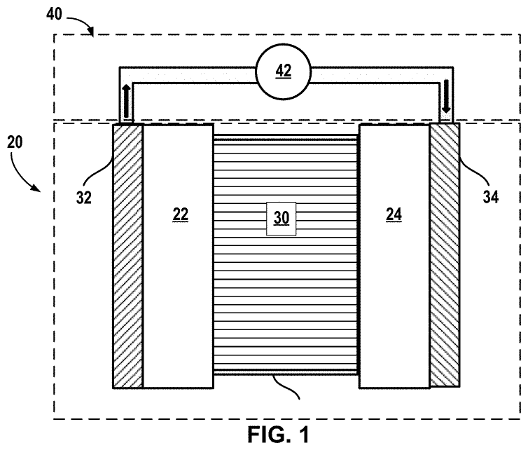

For example, an exemplary and schematic illustration of an electrochemical cell (also referred to as the lithium ion battery or battery) 20 is shown in FIG. 1. Electrochemical cell or lithium ion battery 20 includes a negative electrode 22 (also referred to as a negative electrode layer 22), a positive electrode 24 (also referred to as a positive electrode layer 24), and a separator 26 (e.g., a microporous polymeric separator) disposed between the negative and positive electrodes 22, 24. The space between (e.g., the separator 26) the negative electrode 22 and positive electrode 24 can be filled with the electrolyte 30. If there are pores inside the negative electrode 22 and positive electrode 24, the pores may also be filled with the electrolyte 30. In alternative embodiments, a separator 26 is not included if a solid electrolyte is used.

Any appropriate electrolyte 30, whether in solid, liquid, or gel form, capable of conducting lithium ions between the negative electrode 22 and the positive electrode 24 may be used in the battery 20. In certain aspects, the electrolyte 30 may be a non-aqueous liquid electrolyte solution that includes a lithium salt dissolved in an organic solvent or a mixture of organic solvents. Numerous conventional non-aqueous liquid electrolyte 30 solutions may be employed in the lithium-ion battery 20.

The negative electrode assembly may include a negative electrode current collector 32 positioned at or near the negative electrode 22 and a positive electrode current collector 34 may be positioned at or near the positive electrode 24 to form the positive electrode assembly. The negative electrode current collector 32 and positive electrode current collector 34 respectively collect and move free electrons to and from an external interruptible external circuit 40. A load device 42 in the circuit 40 connects the negative electrode 22 (through its current collector 32) and the positive electrode 24 (through its current collector 34).

While the load device 42 may be any number of known electrically-powered devices, a few specific examples of power-consuming load devices include an electric motor for a hybrid vehicle or an all-electrical vehicle, a laptop computer, a tablet computer, a cellular phone, and cordless power tools or appliances, by way of non-limiting example. The load device 42 may also be a power-generating apparatus that charges the battery 20 for purposes of storing energy.

The battery 20 can generate an electric current during discharge by way of reversible electrochemical reactions that occur when the external circuit 40 is closed (to connect the negative electrode 22 and the positive electrode 24) when the negative electrode 22 contains a relatively greater quantity of inserted lithium. The intercalated lithium at the negative electrode 22 is oxidized during discharge to produce electrons and lithium ions that flow to the positive electrode 24 through the external circuit 40 and separator 26, respectively. The lithium ion battery 20 can be charged or re-powered/re-energized at any time by connecting an external power source to reverse the electrochemical reactions that occur during battery discharge. The connection of an external power source to the lithium ion battery 20 compels the otherwise non-spontaneous flow of electrons back towards the negative electrode 22 through the external circuit 40, and lithium ions, which are carried by the electrolyte 30 across the separator 26 back towards the negative electrode 22, to replenish it with intercalated lithium for consumption during the next battery discharge event.

As such, a complete discharging event followed by a complete charging event is considered to be a cycle, where lithium ions are cycled between the positive electrode 24 and the negative electrode 22. The external power source that may be used to charge the lithium ion battery 20 may vary depending on the size, construction, and particular end-use of the lithium ion battery 20. Some notable and exemplary external power sources include, but are not limited to, an AC wall outlet and a motor vehicle alternator.

The separator 26 operates as both an electrical insulator and a mechanical support, by being sandwiched between the negative electrode 22 and the positive electrode 24 to prevent physical contact and thus, the occurrence of a short circuit. The separator 26, in addition to providing a physical barrier between the negative and positive electrodes 22, 24, can provide a minimal resistance path for internal passage of lithium ions (and related anions) for facilitating functioning of the battery 20. The separator 26 also contains the electrolyte solution in a network of open pores during the cycling of lithium ions, to facilitate functioning of the battery 20. The separator 26 may comprise, for example, a microporous polymeric separator comprising a polyolefin or other materials known to those of skill in the art.

While not shown, in various aspects, the porous separator 26 and the electrolyte 30 in FIG. 1 may be replaced with a solid-state electrolyte (SSE) (not shown) that functions as both an electrolyte and a separator. The SSE may be disposed between the positive electrode 24 and negative electrode 22. The SSE facilitates transfer of lithium ions, while mechanically separating and providing electrical insulation between the negative and positive electrodes 22, 24.

In many battery configurations, each of the negative current collector 32, negative electrode 22, the separator 26, positive electrode 24, and positive current collector 34 are prepared as relatively thin layers (for example, several microns or a millimeter or less in thickness) and assembled in layers connected in electrical parallel arrangement to provide a suitable energy package. The negative electrode current collector 32 and positive electrode current collector 34 respectively collect and move free electrons to and from an external circuit 40.

Furthermore, the battery 20 can include a variety of other components that while not depicted here are nonetheless known to those of skill in the art. For instance, the lithium ion battery 20 may include a casing, gaskets, terminal caps, tabs, battery terminals, and any other conventional components or materials that may be situated within the battery 20, including between or around the negative electrode 22, the positive electrode 24, and/or the separator 26, by way of non-limiting example. The battery 20 shown in FIG. 1 includes a liquid electrolyte 30 and shows representative concepts of battery operation. However, the battery 20 may also be a solid-state battery that includes a solid-state electrolyte that may have a different design, as known to those of skill in the art.

In various aspects, a negative electrode (e.g., negative electrode 22) includes a first negative electroactive material comprising a lithium host material capable of functioning as a negative terminal of a lithium ion battery. In certain variations, the first negative electroactive materials may be intermingled with an electronically conductive material that provides an electron conduction path and/or at least one polymeric binder material as described herein that improves the structural integrity of the electrode.

The first electroactive material may include lithium-graphite intercalation compounds, lithium-silicon intercalation compounds, compounds containing tin, lithium alloys and lithium titanate Li₄₊ₓTi₅O₁₂, where 0≤x≤3, such as Li₄Ti₅O₁₂ (LTO), which may be a nano-structured LTO. Examples of silicon-containing alloys, such as binary and ternary alloys, that can serve as lithium-silicon intercalation compounds include but are not limited, silicon (Si), silicon oxide, Si—Sn, SiSnFe, SiSnAl, SiFeCo, and the like.

Additionally, the negative electrode 22 can include an electrically conductive material and a polymeric binder. Generally, select electrically conductive materials may be included in an electrode, like negative electrode 22, to improve electronic conduction, including both local and bulk electronic transport. Examples of typical electrically conductive material include, but are not limited to, carbon black (such as KETJEN™ black), graphite, acetylene black (such as DENKA™ black), carbon nanotubes, carbon fibers, carbon nanofibers, graphene, graphene nanoplatelets, graphene oxide, nitrogen-doped carbon, metallic powder (e.g., copper, nickel, steel), liquid metals (e.g., Ga, GaInSn), a conductive polymer (e.g., include polyaniline, polythiophene, polyacetylene, polypyrrole, and the like) and combinations thereof.

In accordance with certain aspects of the present disclosure, certain high-aspect ratio particles may be used as the electrically conductive material and prepared in accordance with certain aspects of the present disclosure as described herein. As discussed above, exemplary high aspect ratios may range from about 100 to about 5,000 or greater, for example. Such electrically conductive material in particle form may have an axial geometry. The term “axial geometry” refers to particles generally having a fibrous, tube, rod, or otherwise cylindrical shape having an evident elongated axis. Other high aspect ratio particles may be platelets. Notably, these high aspect ratio carbon-based conductive additives may be nanoparticles that are “nano-sized” or “nanometer-sized” and have at least one spatial dimension that is less than about 10 μm (i.e., 10,000 nm), optionally less than about 1 μm (i.e., 1,000 nm), optionally less than about 0.5 μm (i.e., 500 nm), optionally less than about 0.4 μm (i.e., 400 nm), optionally less than about 0.3 μm (i.e., 300 nm), optionally less than about 0.2 μm (i.e., 200 nm), and in certain variations, optionally less than about 0.1 μm (i.e., 100 nm). It should be noted that so long as at least one dimension of the nanoparticle falls within the above-described nano-sized scale (for example, diameter), one or more other axes may well exceed the nano-size (for example, length and/or width). By way of example, nanometer-sized high aspect ratio carbon-based conductive additives used in accordance with certain aspects of the present disclosure may include graphene nanoplatelets (GNP), carbon nanofibers (CNF), and carbon nanotubes (CNT).

Graphene nanoplatelets generally refers to a nanoplate or stack of graphene layers. By way of non-limiting example, the graphene nanoplatelets have an average lateral dimension of greater than or equal to about 100 nm to less than or equal to about 30 μm and a thickness of less than or equal to about 250 nm, for example, from about 1 nm to about 250 nm.

Carbon nanofibers are generally produced by carbonizing or graphitizing carbon fiber precursor material fibers, such as polyacrylonitrile (PAN), petroleum pitch, or rayon precursors, by way of example. Carbon fibers and graphite fibers are made and heat-treated at different temperatures and thus each has different carbon content. Typically, a carbon fiber has at least about 90% by weight carbon. The carbon nanofibers may be chopped or milled filaments.

Carbon nanotubes (CNT) may be a single-walled carbon nanotube species (SWNT) comprising one graphene sheet or a multi-walled carbon nanotube (MWNT) species comprising multiple layers of graphene sheets that are concentrically arranged or nested within one another. A single-walled nanotube (SWNT) is similar to a flat graphene sheet rolled into a cylinder. A multi-walled nanotube (MWNT) resembles stacked sheets that have been rolled up into cylinders. In certain aspect, the carbon nanotubes are single walled carbon nanotubes (SWNTs).

In certain aspects, the carbon-based high-aspect ratio electrically conductive particles are also high surface area particles, for example, having a surface area of greater than or equal to about 25 m²/g, greater than or equal to about 50 m²/g, greater than or equal to about 65 m²/g, greater than or equal to about 75 m²/g, greater than or equal to about 100 m²/g, greater than or equal to about 250 m²/g, greater than or equal to about 500 m²/g, greater than or equal to about 750 m²/g, greater than or equal to about 1,000 m²/g, greater than or equal to about 1,200 m²/g, or greater than or equal to about 1500 m²/g; from greater than or equal to about 25 m²/g to less than or equal to about 75 m²/g, greater than or equal to about 50 m²/g to less than or equal to about 100 m²/g, greater than or equal to about 25 m²/g to less than or equal to about 1,500 m²/g, greater than or equal to about 250 m²/g to less than or equal to about 1,500 m²/g, in certain aspects, greater than or equal to about 250 m²/g to less than or equal to about 750 m²/g, greater than or equal to about 500 m²/g to less than or equal to about 750 m²/g, or alternatively, greater than or equal to about 750 m²/g to less than or equal to about 1500 m²/g.

In a porous composite electrode, polymeric binder can create a matrix retaining the first negative electroactive material and electrically conductive material in position within the negative electrode having pores. Polymeric binder can fulfill multiple roles in an electrode, including: (i) enabling the electronic and ionic conductivities of the composite electrode, (ii) providing the electrode integrity, e.g., the integrity of the electrode and its components, as well as its adhesion with the current collector, and (iii) participating in the formation of solid electrolyte interphase (SEI), which plays an important role as the kinetics of lithium intercalation is predominantly determined by the SEI.

As used herein, the term “polymeric binder” includes polymer precursors used to form the polymeric binder, for example, monomers or monomer systems that can form any one of the polymeric binders disclosed above. Such precursors may also include a carrier or solvent. Examples of suitable polymeric binders, include but are not limited to, polyvinylidene difluoride (PVDF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), poly(acrylic acid) PAA, polyimide, polyamide, sodium alginate, lithium alginate, and combinations thereof.

In some embodiments, the polymeric binder may be a non-aqueous solvent-based polymer or an aqueous-based polymer. In particular, the polymeric binder may be a non-aqueous solvent-based polymer that can demonstrate less capacity fade, provide a more robust mechanical network and improved mechanical properties to handle silicon particle expansion more effectively, and possess good chemical and thermal resistance. For example, the polymeric binder may include polyimide, polyamide, polyacrylonitrile, polyacrylic acid, a salt (e.g., potassium, sodium, lithium) of polyacrylic acid, polyacrylamide, polyvinyl alcohol, carboxymethyl cellulose, or a combination thereof. The first negative electroactive material may be intermingled with one or more electrically conductive materials (such as the high aspect ratio carbon-based conductive additives described above) and at least one polymeric binder. For example, the first electroactive materials and electronically or electrically conducting materials may be slurry cast with such binder(s).

In various aspects, the first negative electroactive material may be present in the negative electrode in an amount, based on total weight of the negative electrode, of greater than or equal to about 50 weight %, optionally greater than or equal to about 60 weight %, optionally greater than or equal to about 70 weight %, optionally greater than or equal to about 80 weight %, optionally greater than or equal to about 90 weight %, optionally greater than or equal to about 95 weight %, or optionally about 98 weight %; or from greater than or equal to about 50 weight % to less than or equal to about 99 weight % of the electroactive material particles, optionally greater than or equal to about 50 weight % to less than or equal to about 98 weight %, optionally greater than or equal to about 50 weight % to less than or equal to about 97 weight %, optionally greater than or equal to about 60 weight % to less than or equal to about 95 weight %, optionally greater than or equal to about 70 weight % to less than or equal to about 95 weight %, and in certain aspects, optionally greater than or equal to about 80 weight % to less than or equal to about 95 weight.

Additionally or alternatively, the electrically conductive particles, such as carbon-based high-aspect ratio conductive particles, may be cumulatively present in the negative electrode in an amount, based on total weight of the negative electrode, of greater than or equal to about 0.1 weight %, greater than or equal to about 1 weight %, greater than or equal to about 3 weight %, greater than or equal to about 5 weight %, greater than or equal to about 10 weight %, greater than or equal to about 15 weight %, or about 20 weight %. The electrically conductive particles, such as carbon-based high-aspect ratio conductive particles, may be cumulatively present in the negative electrode in an amount, based on total weight of the negative electrode, of greater than or equal to about 0.1 weight % to less than or equal to about 20 weight %, optionally greater than or equal to about 1 weight % to less than or equal to about 20 weight %, optionally greater than or equal to about 5 weight % to less than or equal to about 20 weight %.

Additionally or alternatively, the polymeric binder may be present in the negative electrode in an amount, based on total weight of the negative electrode, of greater than or equal to about 0.5 weight %, greater than or equal to about 1 weight %, greater than or equal to about 3 weight %, greater than or equal to about 5 weight %, greater than or equal to about 10 weight %, greater than or equal to about 15 weight %, or greater than or equal to about 20 weight %. The polymeric binder may be present at greater than or equal to about 0.5 weight % to less than or equal to about 30 weight %, optionally greater than or equal to about 1 weight % to less than or equal to about 25 weight %, optionally greater than or equal to about 5 weight % to less than or equal to about 25 weight %, optionally greater than or equal to about 5 weight % to less than or equal to about 20 weight %.

The negative current collector 32 may include metal, such as a metal foil, a metal grid or screen, slit or woven mesh or expanded metal. The negative current collector 32 may be formed from copper, aluminum, nickel, or any other appropriate electrically conductive material known to those of skill in the art.

In some embodiments, the negative electrode 22 may include: (i) the first electroactive material in an amount of about 50 weight % to about 99 weight % or about 50 weight % to about 98 weight %, based on total weight of the negative electrode; (ii) the electrically conductive material and particularly the conductive carbon-based particles in an amount of about 0.1 weight % to about 15 weight % based on total weight of the negative electrode; and (iii) a cumulative amount of polymers, including polymeric binder and any stabilizing polymer as discussed further below, in an amount of about 0.5 weight % to about 20 weight %; optionally greater than or equal to about 0.5 weight % to less than or equal to about 15 weight % based on total weight of the negative electrode.

The positive electrode 24 may be formed from a second positive electroactive material that can sufficiently undergo lithium intercalation and deintercalation while functioning as the positive terminal of the lithium ion battery 20. The positive electrode 24 may also include a polymeric binder material to structurally fortify the lithium-based active material and an electrically conductive material, including carbon-based high-aspect ratio conductive particles described above. One exemplary common class of known materials that can be used to form the positive electrode 24 is layered lithium transitional metal oxides.

A second positive electroactive material for a positive electrode 24 may be one of a layered-oxide cathode, a spinel cathode, a polyanion cathode, a lithium-sulfur cathode, and the like. For example, in certain embodiments, the positive electrode 24 may comprise layered-oxide cathodes (e.g., rock salt layered oxides), or may comprise one or more lithium-based positive electroactive materials selected from LiNiₓMn_{y}Co_{1-x-y}O₂ (where 0≤x≤1 and 0≤y≤1, referred to generally as “NMC”)), NMC111, NMC523, NMC622, NMC 721, NMC811, LiNiₓMn₁₋ₓO₂ (where 0≤x≤1), Li₁₊ₓMO₂ (where M is one or more of Mn, Ni, Co, and Al and 0≤x≤1) (for example LiCoO₂ (LCO), LiNiO₂, LiMnO₂, LiNi_{0.5}Mn_{0.5}O₂, NCA, and the like). Spinel cathodes comprise one or more lithium-based positive electroactive materials selected from lithium manganese oxide (Li₍₁₊ₓ₎Mn₍₂₋ₓ₎O₄), where x is typically less than 0.15, including LiMn₂O₄(LMO) and lithium manganese nickel oxide LiMn_{1.5}Ni_{0.5}O₄ (LMNO). Olivine type cathodes comprise one or more lithium-based positive electroactive material such as LiV₂(PO₄)₃, LiFePO₄, LiCoPO₄, and LiMnPO₄. Tavorite type cathodes comprise, for example, LiVPO₄F. Borate type cathodes comprise, for example, one or more of LiFeBO₃, LiCoBO₃, and LiMnBO₃. Silicate type cathodes comprise, for example, Li₂FeSiO₄, Li₂MnSiO₄, and LiMnSiO₄F. Lithium-sulfur based cathodes include sulfur-based electroactive materials, for example, elemental sulfur (S) and/or Li₂Sₓ where 1≤x≤8, for example one or more of S, S₈, Li₂S₈, Li₂S₆, Li₂S₄, Li₂S₂, and Li₂S. In still further variations, the positive electrode may comprise one or more other positive electroactive materials, such as one or more of dilithium (2,5-dilithiooxy)terephthalate and polyimide. In various aspects, the positive electroactive material may be optionally coated (for example by LiNbO₃ and/or Al₂O₃) and/or may be doped (for example by one or more of magnesium (Mg), aluminum (Al), and manganese (Mn)).

In other variations, the positive electroactive material may include layered materials like lithium cobalt oxide (LiCoO₂), lithium nickel oxide (LiNiO₂), a lithium nickel manganese cobalt oxide (Li(NiₓMn_{y}Co_{z})O₂), where 0≤x≤1, 0≤y≤1, 0≤z≤1, and x+y+z=1, including LiMn_{0.33}Ni_{0.33}Co_{0.33}O₂, a lithium nickel cobalt metal oxide (LiNi_{(1-x-y)}CoₓM_{y}O₂), where 0<x<1, 0<y<1 and M may be Al, Mn, or the like. Other known lithium-transition metal compounds such as lithium iron phosphate (LiFePO₄) or lithium iron fluorophosphate (Li₂FePO₄F) can also be used.

Like in the negative electrode, the positive electrode 24 may include second positive electroactive materials intermingled with an electronically conductive material (e.g., high aspect ratio carbon-based conductive additives) and/or at least one polymeric binder material and any stabilizing polymer as described above in the relative amounts described above in the context of the negative electrode.

The positive current collector 34 may include metal, such as a metal foil, a metal grid or screen, slit or woven mesh, or expanded metal. In certain variations, the positive current collector 34 may be formed from aluminum, stainless steel and/or nickel or any other appropriate electrically conductive materials known to those of skill in the art.

The present disclosure provides methods of forming an electrode conductive filler precursor in the form of a carbon-based particle dispersion that advantageously provides a shelf-stable colloid that can be used to form electrodes having improved electrical performance. Methods of preparing an electrode, whether a negative electrode (e.g., negative electrode 22) or positive electrode (e.g., positive electrode 24) are also provided herein. The methods described herein can be advantageously used for small-scale or large-scale processes.

In certain aspects, the present disclosure provides methods of making an electrode conductive filler precursor dispersion. The method may comprise mixing conductive carbon-based particles dispersed in a liquid at a high shear rate for debundling. The conductive carbon-based particles may be selected from the group consisting of: graphene nanoplatelet (GNP), carbon nanofibers (CNF), carbon nanotubes (CNT), and combinations thereof. In certain aspects, a loading of the high aspect ratio conductive carbon-based particles is greater than or equal to about 3% w/w to less than or equal to about 20% w/w in a liquid (e.g., in NMP solvent). As discussed above, these high aspect ratio carbon-based conductive additives are particularly susceptible to agglomeration and reagglomeration in liquids, which results in their uneven distribution in the eventual electrode made from any conductive fillers. For example, although the surface tension for NMP solvent is well matched to disperse the carbon-based additives, their colloidal stability window is still limited to very low solids content (e.g., below 1% w/w).

A solvent is also added to the conductive carbon-based particles prior to the high shear mixing so that the conductive carbon-based particles are suspended in liquid. Non-limiting examples of suitable solvents include non-aqueous solvents selected from the group consisting of N-methyl-2-pyrrolidone (NMP), dimethylformamide (DMF), dimethyl sulfoxide (DMSO), propylene carbonate (PC), acetonitrile, tetrahydrofuran (THF), and combinations thereof. In some embodiments, the solvent may be aprotic, preferably polar. In certain embodiments, the solvent comprises N-methyl-2-pyrrolidone (NMP).

In certain aspects, a solids content of this mixture of high aspect ratio carbon-based conductive additives and solvent may be greater than or equal to about be greater than or equal to about 3% w/w to less than or equal to about 60% w/w; optionally greater than or equal to about 20% w/w and less than or equal to about 60% w/w, or alternatively, optionally greater than or equal to about 3% w/w and less than or equal to about 20% w/w; optionally greater than or equal to about 5% w/w and less than or equal to about 15% w/w. A balance of the dispersion or mixture may be solvent.

The high aspect ratio carbon-based conductive additives in solvent are subjected to high shear milling to physically debundle their initial agglomerate content, which then significantly reduces their coated porosity. A variety of commercial mixing technology is available to impose a high shear rate on the precursor dispersion for these carbon-based conductive additives. These various materials can be blended or mixed by methods and equipment known in the art, such as for example, mixers (e.g., planetary, rotary), resonance dispersion, sonic and ultrasonic dispersion, centrifugal force, magnetic stirrers, kneaders, and the like.

The rotational speeds used to reach a given applied shear rate may vary and depend on specific mixer geometry. The various materials can be blended or mixed by methods and equipment known in the art, such as for example, mixers (e.g., planetary, rotary), resonance dispersion, sonic and ultrasonic dispersion, centrifugal force, magnetic stirrers, kneaders, and the like. Thus, the speed for high shear mixing may vary, but in certain variations, may be greater than or equal to about 1,000 rpm to less than or equal to about 10,000 rpm, optionally greater than or equal to about 1,000 rpm to less than or equal to about 5,000 rpm, optionally greater than or equal to about 1,000 rpm to less than or equal to about 3,000 rpm, for example, about 2,000 rpm.

In one example of an embodiment, a planetary centrifugal mixer commercially available as a THINKY ARE-310™ instrument has a fixed rotation:revolution speed ratio of 1:2.5. The revolution speed for THINKY ARE-300™ mixer high shear mixing may vary from greater than or equal to about 400 rpm to less than or equal to about 5,000 rpm, but in certain variations, may be greater than or equal to about 400 rpm to less than or equal to about 5,000 rpm, optionally greater than or equal to about 400 rpm to less than or equal to about 3,000 rpm, optionally greater than or equal to about 1,000 rpm to less than or equal to about 3,000 rpm, for example, about 2,000 rpm.

The method of preparing an electrode conductive filler precursor dispersion also includes introducing a stabilizing polymer or polymer dispersant. The stabilizing polymer is added to limit the agglomerate re-growth and facilitate longer shelf stability for the stock carbon-based particle dispersions. In certain variations, the stabilizing polymer comprises an aromatic group. In one variation, the stabilizing polymer comprises polyvinyl-4-pyridine (PVPy). In certain aspects, the PVPy polymer having a pendant aromatic group appears to provide steric stabilization of a SWNT dispersion in NMP solvent by adsorbing on the graphitic-like carbon surface. The stabilizing polymer is optionally added to the electrode precursor composition at greater than or equal to about 1 mg polymer per m² carbon surface (or simply, 1 mg/m²) to less than or equal to about 5 mg/m² loading to suppress reagglomeration.

In certain variations, the electrode conductive filler precursor dispersion comprises the conductive carbon-based particle at greater than or equal to about 3 weight % to less than or equal to about 20 weight %. Further, the electrode conductive filler precursor dispersion comprises the solvent at greater than or equal to about 70 weight % to less than or equal to about 97 weight %. The stabilizing polymer may be present at greater than or equal to about 1 weight % to less than or equal to about 8 weight % of the electrode conductive filler precursor dispersion, optionally greater than or equal to about 3 weight % to less than or equal to about 5 weight %, and in certain variations, about 4 weight %. In addition to the amounts of the stabilizing polymer provided above, other conventional additives or components may also be included in the conductive filler electrode precursor dispersion.

The imparted colloidal stabilization of the conductive carbon dispersion can be quantified by shear-thinning rheology measurement. In particular, the viscosity hysteresis at 0.1/sec can be followed for a 0.3% w/w SWNT dispersion in solvent such as NMP after applying a 1000/sec shear rate. The polymer adsorption and imparted colloidal stabilization is confirmed if the measured viscosity at 0.1/sec remains within 5% for the 0.01 to 1000/sec shear up-ramp relative to the 1000 to 0.01/sec down-ramp immediately following.

In this manner, the present disclosure provides a more efficient milling approach for carbon-based particles, because stock carbon dispersions are processed at high solids levels without the need for adding any milling or grinding media. Thus, the high shear milling to debundle the carbon-based particles may be substantially free of any additional milling or grinding media (additional solid components). In this manner, the avoidance of using any milling media provides a process having improved transfer waste and throughput. Moreover, the electrode precursors formed via the present disclosure provide for safer handling of carbon-based additives, by using a liquid precursor that minimizes dust/particulate matter emissions during battery manufacturing as compared to current methods that transport and handle dry carbon powders.

The stabilizing polymer is then added to limit the agglomerate re-growth (of the carbon-based particles). This is particularly advantageous where the electrode precursors may be stored and thus provides a good shelf life for carbon dispersions. In certain variations, may thus have a shelf life of greater than or equal to about 7 days or one week, optionally greater than or equal to about 14 days or two weeks, optionally greater than or equal to about 21 days or three weeks, and in certain aspects, greater than or equal to about 30 days or one month, as will be described further below. In the presence of the stabilizing polymer, the gels that may form or any phase separation that may occur with the higher aspect ratio carbon-based particles are still easily dispersed with gentle mixing.

In certain variations, the conductive carbon-based particle comprises graphene nanoplatelet (GNP) at greater than or equal to about 1 weight % to less than or equal to about 15% weight %, optionally at about 15% weight % of the electrode precursor dispersion. After introducing the stabilizing polymer and solvent, the electrode precursor dispersion of GNP is a liquid. In other variations, the conductive carbon-based particle comprises carbon nanofibers (CNF) at greater than or equal to about 1 weight % to less than or equal to about 12% weight % of the electrode precursor dispersion, optionally at about 12% weight % of the electrode precursor dispersion. After introducing the stabilizing polymer and solvent, the electrode precursor dispersion of CNF is a gel. In yet other variations, the conductive carbon-based particle comprises carbon nanotubes (CNT) at greater than or equal to about 1 weight % to less than or equal to about 5% weight %, optionally at about 5% weight % of the electrode precursor dispersion. After introducing the stabilizing polymer and solvent, the electrode precursor dispersion of CNTs is a gel.

The electrode conductive filler precursor may be considered to be a stable colloid with a shelf-stability. This means that the electrode conductive filler precursor may be considered to be substantially free of syneresis—separation of liquids from a gel phase or solids from a liquid phase—for greater than or equal to about 7 days. Syneresis may generally involve expulsion of solvent from the compacting gel network, as well. By “substantially free” it is meant that phase separation or syneresis is absent to the extent that the physical properties and limitations attendant with its presence are avoided. For example, as noted above, even if some separation of phases or settling occurs, if the liquid admixture with the high aspect ratio carbon-based conductive particles can be gently stirred or mixed at low speeds, to create an even dispersion, it may be considered to be substantially free of syneresis and thus shelf-stable. In certain aspects, such gentle mixing may include rod stirring or roller milling without milling media (e.g., zirconia beads) with low applied shear rates, as is known in the art.

In certain embodiments, a liquid electrode precursor that is “substantially free” of syneresis has less than about 5% by volume of phase separation, more preferably less than about 4% by volume, optionally less than about 3% by volume, optionally less than about 2% by volume, optionally less than about 1% by volume, optionally less than about 0.5% by volume and in certain embodiments comprises 0% by volume of phase separation.

In this manner, the present disclosure provides methods to achieve a more uniform distribution of carbon-based particles in battery electrodes, by preparing an electrode conductive filler precursor that serves as a master carbon dispersion with high solids levels and a robust shelf-life, which can then be readily mixed into the full electrode slurry for efficient manufacturing throughput. The carbon-based solids for each master dispersion are optimized to mill the initial physical agglomerate content, while an effective amount of a stabilizing polymer is added for colloidal stabilization. The full electrode slurry is then easily mixed in a one-step addition of the binder polymer liquid (for layer mechanical strength) and of a suitable blend of master carbon-based particle dispersions (for local and bulk electronic transport) added to the dry active anode or cathode material powder.

Therefore, in certain other aspects, the present disclosure provides a method of making an electrode comprising mixing an electrode conductive filler precursor dispersion with a binder and electroactive material particles to form a slurry. The polymeric binder may be dry or dispersed in a liquid. The binder and liquid conductive filler precursor may be added to dry anode/cathode electroactive material particles to form slurry. Additional carrier liquid or solvent may be added to the slurry, such as a non-aqueous solvent like those described above. The electrode conductive filler precursor dispersion is like that discussed above and may comprise a conductive carbon-based particle selected from the group consisting of: graphene nanoplatelet (GNP), carbon nanofibers (CNF), carbon nanotubes (CNT), or combinations thereof, a stabilizing polymer comprising polyvinyl-4-pyridine (PVPy), and a solvent.

The various materials can be blended or mixed by methods and equipment known in the art, such as for example, mixers (e.g., planetary, rotary), resonance dispersion, sonic and ultrasonic dispersion, centrifugal force, magnetic stirrers, kneaders, and the like. In certain variations, the mixing is selected from the group consisting of resonance dispersion, sonic and ultrasonic dispersion, planetary/rotary, centrifugal force mixing, and combinations thereof. In certain aspects, the electrode conductive filler precursor dispersion, binder, and electroactive material particles may be subjected to low intensity mixing to achieve a homogeneous electrode slurry. The applied shear to debundle the carbon dispersion is quantified by measuring the resulting viscous heating. In certain aspects, the final dispersion temperature increases by greater than or equal to about 20° C. to less than or equal to about 60° C. to achieve the necessary milling intensity at high shear rate. The dispersion/mixture milling time may range from greater than or equal to about 10 minutes to less than or equal to about 48 hours depending on the milling shear rate, optionally greater than or equal to about 10 minutes to less than or equal to about 24 hours.

In certain embodiments, the electrode slurry comprises the conductive carbon-based particle at greater than or equal to about 5 weight % to less than or equal to about 25 weight %, the electroactive material particles at greater than or equal to about 50 weight % to less than or equal to about 80 weight %, the solvent at greater than or equal to about 1 weight % to less than or equal to about 5 weight %, and a total amount of binder and stabilizing polymer at greater than or equal to about 5 weight % to less than or equal to about 15 weight %.

Once the slurry is formed, the method includes applying the slurry to a current collector or other substrate. The slurry may be applied to or cast on a current collector (e.g., negative current collector 32 or positive current collector 34 in FIG. 1) and volatilized to form the negative or positive electrode. The slurry may be deposited using any suitable technique. As examples, the slurry may be cast, spread, or coated on the surface of the current collector using a slot die coater.

The deposited slurry may be exposed to a drying process in order to remove any remaining solvent and/or water. The slurry may be dried to form an electrode active layer disposed on the current collector. Drying may be accomplished using any suitable technique. Volatilizing of the solvent in the slurry can be performed by drying the slurry, for example, in a zone dryer, at a temperature to evaporate the solvent and form the electrode. For example, the drying is conducted at ambient conditions (e.g., at room temperature, about 18° C. to 22° C., and 1 atmosphere). Drying may be performed at an elevated temperature ranging from greater than or equal to about 60° C. to less than or equal to about 150° C. In some examples, vacuum may also be used to accelerate the drying process. As one example of the drying process, the deposited slurry may be exposed to vacuum at about 100° C. for about 12 to 24 hours.

The drying process results in the formation of the electrode, namely the electrode active layer disposed on the current collector. In an example, the thickness of the dried slurry (e.g., electrode active layer) ranges from greater than or equal to about 5 μm to less than or equal to about 200 μm, optionally from greater than or equal to about 10 μm to less than or equal to about 100 μm.

In certain aspects, the method may further include a consolidation step, where the electrode active layer and current collector have pressure applied or are calendared together.

In some embodiments, the slurry comprises greater than or equal to about 0.05 weight % to less than or equal to about 10 weight % of the carbon-based conductive additive on a dry basis, greater than or equal to about 5 weight % to less than or equal to about 98 weight % of the electroactive material particles on a dry basis, and greater than or equal to about 1 weight % to less than or equal to about 10 weight % of the binder on a dry basis.

The conductive carbon-based particle is evenly distributed in the electrodes formed by such processes incorporating the inventive electrode precursor dispersions with carbon-based particle dispersions. In certain variations, the conductive carbon-based particle may be homogeneously distributed in the electrode.

The methods disclosed herein are especially well-suited to maximizing performance of electrochemical cells, such as lithium ion batteries, by providing an even distribution of carbon-based conductive additives in the electrode active layer. Therefore, the inventive electrode materials have certain advantages, like high energy density, fast charging density, and lower electrical resistance. The resulting more uniform distribution of carbon-based conductive additives in the coated electrode layer can be confirmed by imaging electrode cross-sections with electron microscopy methods known in the art.

For example, where the electrochemical device includes an electrode made according to certain aspects of the present disclosure including evenly distributed high aspect ratio conductive carbon-based particles, the electrochemical cell may substantially maintain charge capacity (e.g., maintain charge capacity within 25% of an initial charge capacity) for at least 150 deep discharge cycles, optionally greater than or equal to about 500 deep discharge cycles, optionally greater than or equal to about 1,000 deep discharge cycles, optionally greater than or equal to about 1,500 deep discharge cycles, and in certain variations, optionally greater than or equal to about 2,000 deep discharge cycles.

It should be further noted that it is believed that electrodes prepared in accordance with various aspects of the present disclosure with evenly distributed high aspect ratio conductive carbon-based particles treated with stabilizing polymer may be provided at relatively lower amounts of the carbon-based particles as compared to a conventional electrode lacking the stabilizing polymer, while achieving the same performance.

### EXAMPLES

### Example 1

The following example evaluates the ability of potential stabilizing polymers to minimize or prevent reagglomeration after debundling conductive carbon-based particles or fillers. Table 1 lists four representative carbon fillers along with select physical properties.

TABLE 1

| | | | BET | PSD | skeletal |
|---|---|---|---|---|---|
| supplier | label | product | (m2/g) | (D50 um) | (g/cc) |
| Soltex | AB | 50-1 | 70 | 2 | 2.0 |
| Tuball | SW-CNT | 0.4% C/2% | 1315 | 5 | 2.0 |
| | | PVDF/NMP | | | |
| Pyrograf | CNF | PR19-XT-HHT | 20 | 100 | 2.0 |
| XG Sciences | GnP | H5 | 65 | 7 | 2.2 |

SOLTEX AB50-1™ is an acetylene black (carbon black for purposes of comparison) with high surface area (BET 70 m²/g); this highly structured carbon has a cylindrical envelope of 100 nm diameter×200 nm length.

A single-wall carbon nanotube (SWNT) from Tuball has a very high external surface area (1315 m²/g) with cylindrical dimensions of 1.6 nm diameter and approximate 5 μm length. This carbon type is again effective for local electronic transport with a significant bend compliance along its tube length. These CNT nanotubes easily form “rope” agglomerates in a solvent-based dispersion, which are detectable by photoluminescence or shear rheology.

PYROGRAF PR19-XT-HHT™ from Applied Sciences, Inc is a carbon nanofiber (CNF) with moderate surface area (20 m²/g) and cylindrical dimensions of approximately 100 nm diameter x˜10 μm length (with an implied aspect ratio of about 100). The HHT fabrication process includes a 3,000° C. heat treatment for graphitization. However, these fibers are highly entangled within an approximate 100 μm spheroidal agglomerate that is difficult to debundle. This carbon type is effective for bulk electronic transport. The thick fiber diameter provides rigidity, while the high aspect ratio leads to a percolation threshold at predicted 5% v/v loading.

Graphene nanoplatelet (GNP) from XG Sciences also has a high surface area (65 m²/g) at approximately 15 nm thickness; these exfoliated platelets have abroad distribution in lateral dimension after milling that is centered at about 15 μm hydrodynamic diameter. This carbon type is again effective for bulk electronic transport due to its rigid thickness, flake length and high aspect ratio.

Mixer Process

A THINKY ARE-310™ instrument is used throughout this example where the planetary centrifugal mixer had a fixed rotation:revolution speed ratio at 1:2.5. All dispersions are mixed in 150 (with a 250AD-201 adaptor) or 300 mL HDPE (high density polyethylene) jars filled between 10-30% capacity. The mill intensity is adjusted with solids loading (1-15% w/w carbon) and revolution speed (1000-2000 rpm), while the mill duration was varied from 3 to 25 minutes. The dispersion temperature is sampled with an IR pyrometer throughout the mill process to target a 50-80° C. plateau temperature which is well below the softening point for the HDPE polymer.

Stabilizing Polymer Analysis

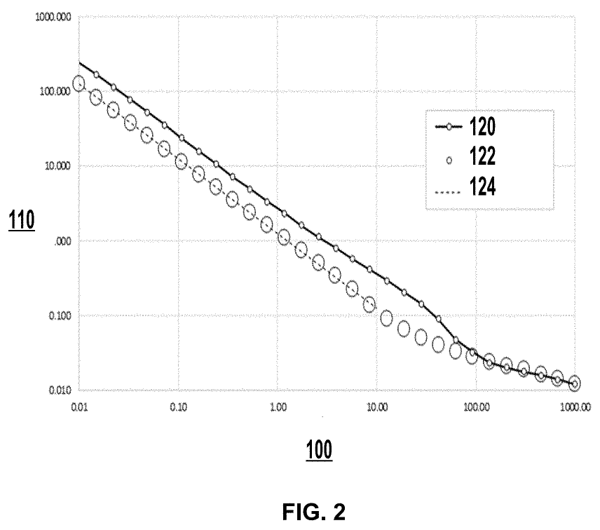

The shear rheology of SWNT dispersion in NMP solvent offers a suitable model system to quantify the resulting colloidal stability from candidate stabilizing polymers (e.g., polymer dispersants). FIG. 2 shows hysteresis of a comparative shear-thinning profile for a dispersion of single wall carbon nanotubes in an NMP solvent without any stabilizing polymer. The y-axis 100 is viscosity in Pa·s and x-axis 110 is shear rate (1/seconds). 120 represents the up ramp, 122 represents the down ramp, and 124 shows the power law (n=−1.00). Thus, FIG. 2 shows the viscosity hysteresis for a 0.3% w/w SWNT dispersion in NMP solvent with 1.5% w/w PVDF polymer (Solay SOLEF® 5130) which is diluted with solvent addition from the commercially available 0.4% stock dispersion manufactured by Tuball.

A “rope agglomerate” with extended length and thereby higher hydrodynamic diameter readily formed with 1 week aging after shear application from the THINKY ARE-310™ mixer at 2,000 rpm; this physical agglomerate is then re-dispersed during the “up” shear-rate ramp protocol shown at 120 for the Anton-Paar MRC 301 rheometer (with a 25 mm diameter parallel plate). The subsequent “down” ramp shown at 122 does not provide sufficient time for the agglomerate to re-form so a viscosity hysteresis is observed in FIG. 2 below about 50/sec shear-rate. This shear rheology is also observed in full electrode slurries with addition of 0.1% w/w SWNT.

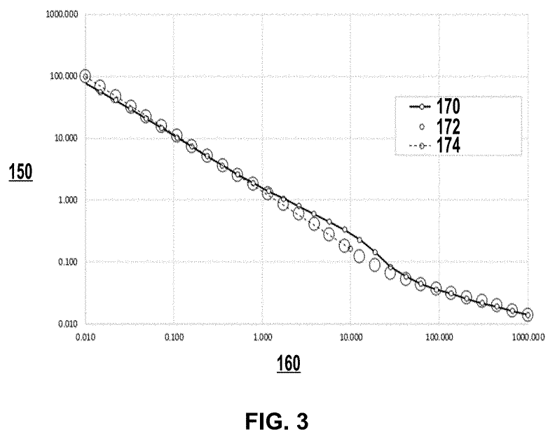

In contrast, there is no apparent viscosity hysteresis after a 1-week hold in FIG. 3. The y-axis 150 is viscosity in Pa·s and x-axis 160 is shear rate (1/seconds). 170 represents the up ramp, 172 represents the down ramp, and 174 shows the power law (n=−1.00). FIG. 3 shows minimal hysteresis in shear-thinning profile for the same SWNT dispersion as in FIG. 2, but now containing PVPy dispersant polymer (60 kD M_{w}) at 2.4 mg (polymer)/m² (carbon) loading. While not limiting the present teachings to any particular theory, this is believed to be attributed to adsorption of the polymer on the outer wall of the hollow SWNT nanotube, which provides the steric stabilization necessary to avoid any significant “rope agglomerate” formation after the 1-week hold. This is consistent with π-orbital coupling between the graphitic-like carbon surface and the pendant aromatic pyridine group attached to the polymer backbone.

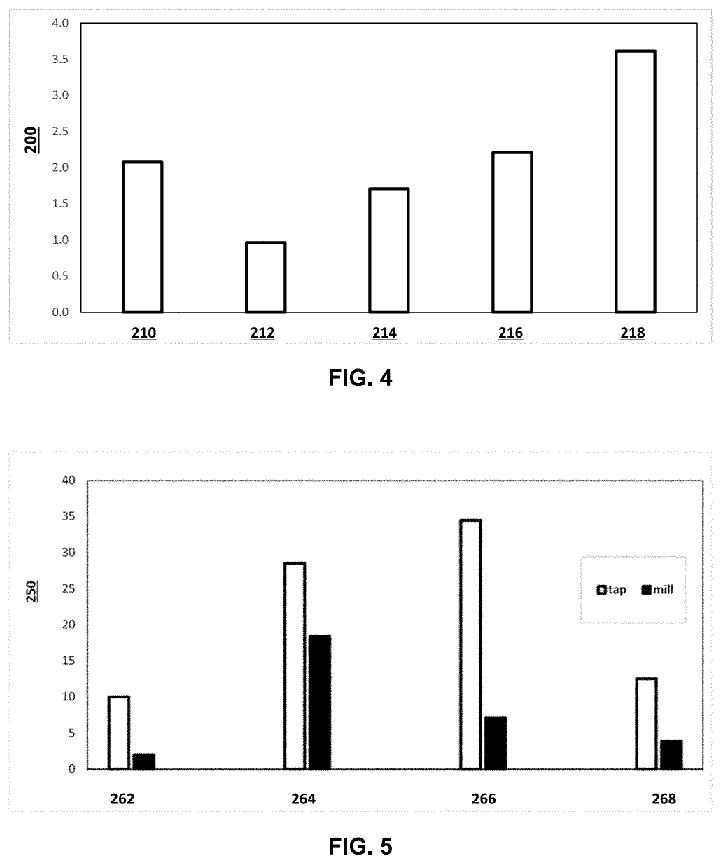

The bar chart in FIG. 4 compares the measured viscosity hysteresis at 0.11/sec for the 0.3% SWNT dispersions after 1-week aging using the following candidate stabilizing polymer classes at the same mg/m² loading The hydrophobic fluoropolymer PVDF (Solvay Solef 5130™, 1,000 kD M_{w}) is present in the control dispersion 210 at a higher 1.5% w/w loading. Dispersion 212 adds the aromatic polyvinyl-4-pyridine PVPy (Aldrich, 60 kD Mw) without acetic acid (HOAc) neutralization. Dispersion 214 adds PVPy and 10% mol/mol acetic acid (HOAc) for neutralization. Dispersion 216 adds a polar polyacrylonitrile (PAN) (Goonvean fiber, dtex 1.0). Finally, 218 adds a polar polyurethane (BYK-425, 30 kD M_{w}). The y-axis 200 represents the viscosity ratio at 0.11/sec for up-ramp versus down-ramp shear-rate profiles.

Although the aromatic PVPy polymer avoided the “rope agglomerate” growth after 1-week of holding as shown in 212, the partial neutralization of this polymer with acetic acid (HOAc) at 10% mol/mol shows for 214 again shows viscosity hysteresis. Although protonation does not disrupt the aromatic ring on the pendant pyridine of PVPy, the cation charge did appear to impede the carbon colloidal stabilization in NMP solvent.

Similarly, the polar polyacrylonitrile (PAN) 216 shows significant hysteresis in the bar chart. A modified polyurethane copolymer (BYK-425) 218 with random hydrogen-bonding urea monomer also had a high viscosity hysteresis. In addition, the hydrophobic polyvinylidene fluoride (PVDF) in the commercial control dispersion 210 (0.4% SW-CNT dispersion in NMP) did not adsorb on the graphitic-like carbon surface, but only increases solution viscosity to reduce the sedimentation rate of the agglomerate that forms.

In summary, stabilizing polymers with pendant aromatic groups provide advantageous stabilization and minimization of reagglomeration for high surface area carbon additives in NMP-based electrode slurries. Although not limiting the present teachings to any particular theory, the pendant aromatic group is believed to drive adsorption of PVPy on graphene surfaces, such as the surfaces of SWNT or MWNT. This phenomenon is also believed to occur in other solvents aside from NMP, including in both aqueous and organic solvent-based dispersions, such as DMSO.

### Example 2

Debundling Carbon Agglomerate at High Solids Content

The carbon-based particle fillers described in Example 1 are likewise analyzed in Example 2 and appear to require high shear milling to physically debundle their initial agglomerate content which significantly reduces their intrinsic porosity. The pore volume for the initial carbon powder is typically measured as a “tap” or “bulk” density. On the other hand, pore volume after milling is measured by coating thickness at an aim gravimetric laydown. Table 2 summarizes the measured “tap” versus “mill” porosity for the four representative carbon types.

TABLE 2

| supplier | label | tap volume | | tap porosity | | tap wetout (NMP) | | mill volume | | mill porosity | | mill wetout (NMP) | |
|---|---|---|---|---|---|---|---|---|---|---|---|---|---|
| Soltex | AB | 10.0 | mL/g | 95.0% | v/v | 9.3% | w/w | 2.0 | mL/g | 75.0% | v/v | 39.3% | w/w |
| Tuball | SW-CNT | 28.6 | mL/g | 98.4% | v/v | 3.0% | w/w | 18.4 | mL/g | 97.6% | v/v (est) | 5.0% | w/w |
| Pyrograf | CNF | 34.5 | mL/g | 98.7% | v/v | 2.5% | w/w | 7.1 | mL/g | 94.1% | v/v (est) | 12.0% | w/w |
| XG Sciences | GNP | 12.5 | mL/g | 96.4% | v/v | 6.7% | w/w | 3.9 | mL/g | 89.7% | v/v (est) | 20.0% | w/w |

FIG. 5 shows a bar chart summary of carbon pore volume reduction after milling for these carbon-based nanoparticles. More specifically, in FIG. 5, the y-axis 250 is pore volume (mL/g) and tap and mill measurements are shown for 260 representing Soltex AB50-1 acetylene black (carbon black particles), 262 representing a single-wall carbon nanotube (SWNT), 264 representing Pyrograf PR19-XT-HHT carbon nanofiber (CNF), and 266 representing graphene nanoplatelet (GNP). As a model system for porosity reduction, the Soltex acetylene black (AB50-1) is measured at an initial pore volume of 10.0 mL/g carbon. This implies a 95.0% v/v porosity and requires a carbon loading at 9.3% w/w or lower to wetout or saturate with NMP solvent. After milling however, the measured pore volume is reduced 5-fold to 2.0 mL/g with implied porosity of 75.0% v/v and a maximum solids of 39.3% w/w at saturation. This porosity change after carbon milling is directly related to physically debundling the initial agglomerate volume with applied shear.

However, a residual agglomerate content persists during milling which can be quantified by the topographical defect density observed for thin layer coatings. For example, “lump” defects are observed on a 40 μm thick coating for Soltex AB carbon from a 15.0% carbon dispersion in water; these defects are also frequently decorated by perimeter cracks due to drying stress. Although the measured thickness for both coatings is identical within experimental error, the residual agglomerate yield is much higher for the lower applied shear rate case (1000 versus 2000 rpm in revolution speed). The higher dispersion temperature due to viscous heating (33 versus 78° C.) is then used as a measure of mill intensity for the THINKY 310 mixer.

To address this challenge to effectively disperse the high surface area carbon filler, conventionally an extensive milling sequence is imposed whereby the carbon filler and dispersion solvent such as NMP are added stepwise to the dry active material to maintain wetout and maximize solids. Zirconia beads (grinding or milling media) are also added in some cases to improve the milling efficiency. This conventional approach requires more cycle time and carries more transfer waste to process, while the specific high surface area carbon fillers still have significant agglomerate volume.

In this example, a more efficient carbon milling approach is developed where each stock carbon dispersion is first processed first at an optimized high solids loading content without the need of any milling media. The stabilizing polymer is then added to limit the agglomerate re-growth with shelf age of the stock carbon dispersions in accordance with certain aspects of the present disclosure. The gels that may form with the higher aspect ratio carbon-based particles are still easily dispersed with gentle mixing. Additionally, a separate binder polymer, such as PVDF, can also be added when preparing the full electrode slurry.

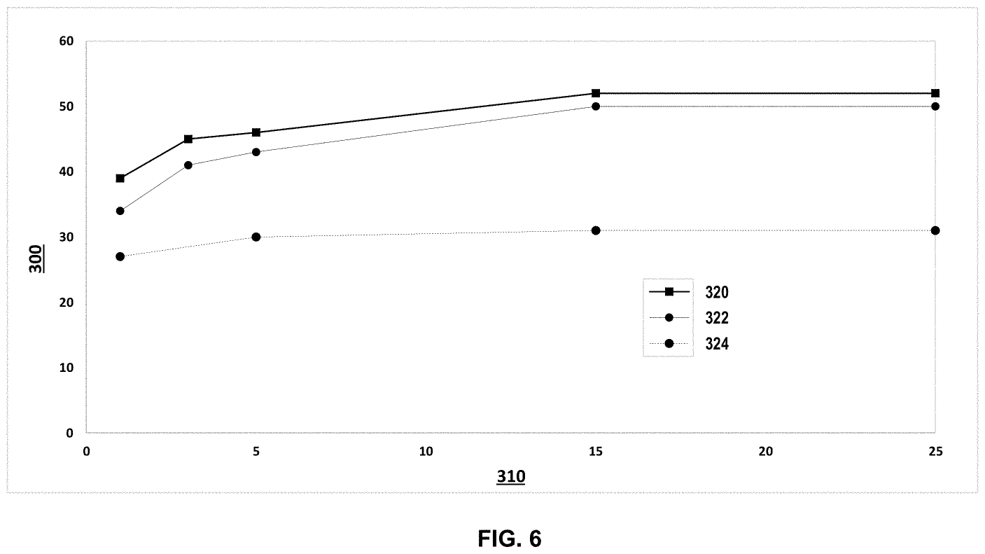

The Pyrograph carbon nanofiber (CNF) is most difficult to debundle with applied shear and thus is used here as a model system. The spheroidal CNF agglomerate can be more simply debundled with applied mechanical shear at high carbon loading as illustrated in FIG. 6 with CNF dispersions formulated in NMP. FIG. 6 shows a mix temperature (° C.) on y-axis 300 versus mix duration (minutes) on x-axis 310. A liquid having 15% graphene nanoparticles is labeled 320. A paste having 10% carbon nanofibers is labeled 322. A liquid having 1% carbon nanofibers is labeled 324. FIG. 6 thus shows a comparison of a CNF dispersion in NMP at 1.0 vs 10.0% w/w loading with 2.4 mg PVPy/m² stabilizing polymer loading. The THINKY 310 mixer is briefly interrupted throughout the 25 minute mill duration to monitor the dispersion temperature with a handheld IR pyrometer. The 1% w/w CNF dispersion only reaches a 30° C. plateau, while the 10% w/w dispersion drove more viscous heating with a 50° C. plateau.

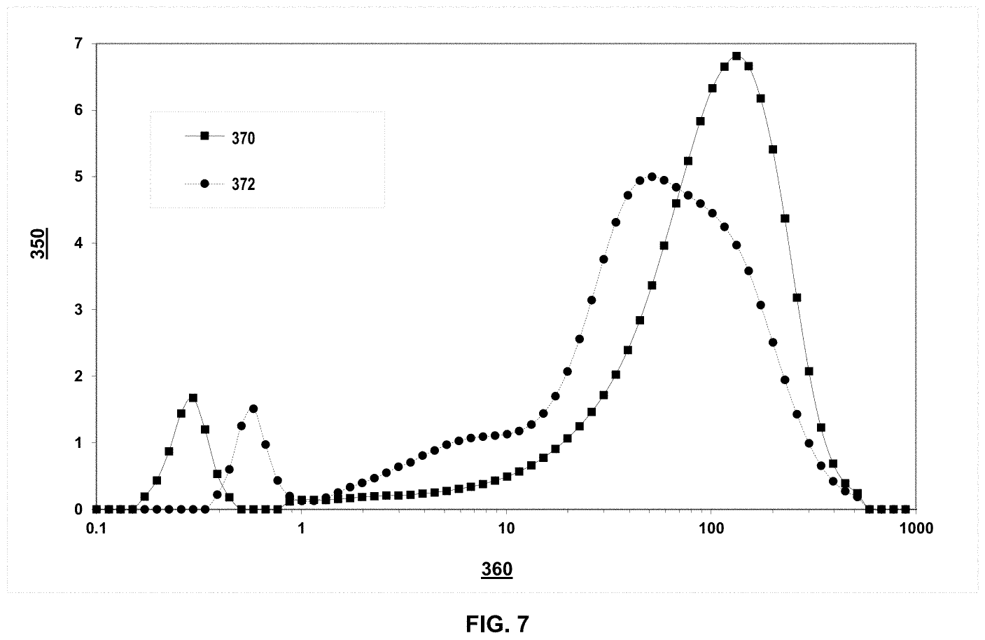

Low Angle Laser Light Scattering (LALLS, Horiba LA 920) is used to measure the particle size distribution (PSD) for both stock dispersions aged for one month. These dispersions are gently mixed with a stir rod before a drawn sample is diluted to 0.1% carbon in additional NMP. A few drops of this diluted sample are then transferred to the NMP reservoir in the LALLS instrument to obtain the Particle Size Distribution plot given in FIG. 7.

FIG. 7 thus shows with volume (%) on y-axis 350 versus particle size (micrometers) on x-axis 360. A material having 10% carbon nanofibers and PVPy stabilizing polymer is labeled 372. A material having 1% carbon nanofibers and PVPy stabilizing polymer is labeled 370.

The stock dispersion at 1.0% w/w loading 370 shows only a major peak at the initial 100 μm agglomerate diameter. A minor peak below 1 μm is assigned to carbon fragments from the milling process. However, the 10% w/w loading dispersion 372 does show a progression to lower particle diameters. The shoulder at 5 μm is consistent with an individual fiber, while the primary peak at 30 μm diameter is assigned to a partially debundled agglomerate. This is direct evidence that milling at high solids content is more effective at dispersing the initial carbon powder. The PSD can be further optimized by increasing the carbon solids incrementally higher from 10% w/w.

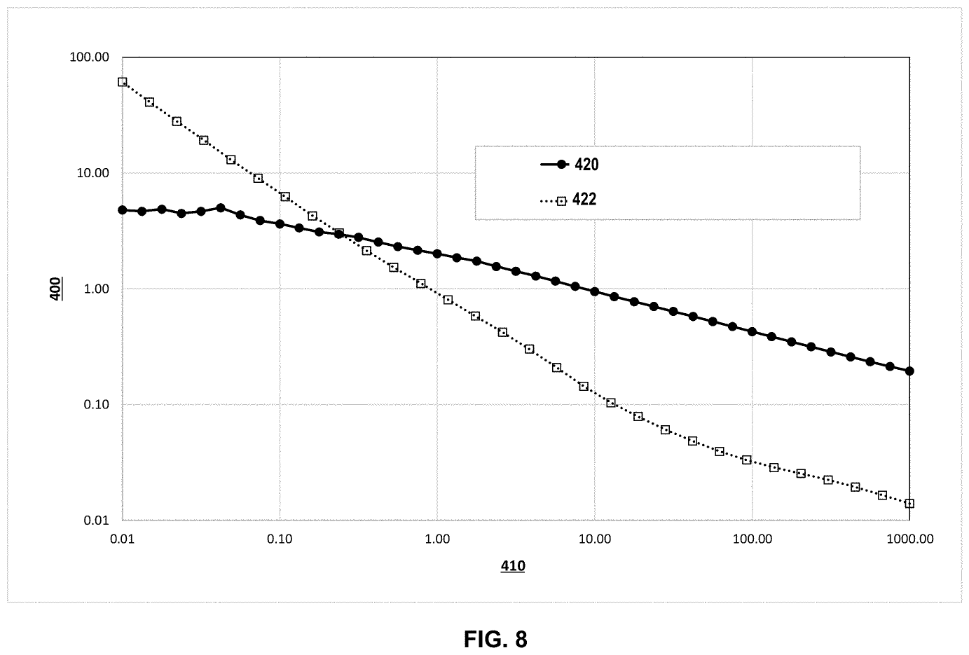

The shear rheology for stock 15% w/w GNP and commercially available Tuball 0.4% w/w SWNT dispersions are compared in FIG. 8. FIG. 8 is a comparison of y-axis 400 viscosity (Pa·s) on a down-ramp versus x-axis 410 shear rate (1/seconds). The precursor dispersion having 15% w/w graphene nanoplatelets (GNP) with PVPy polymer at 2.4 mg/m² is labeled 420, while the commercial dispersion from Tuball with 0.4% w/w single wall nanotube (SWNT) and 2.0% w/w PVDF is labeled 422. The particle size distribution (PSD) for the GNP dispersion 420 shows a broad peak centered at 20 μm which is consistent with SEM micrographs. The 15% w/w GNP master dispersion 420 includes the PVPy and has “liquid-like” rheology that is stable with shelf life so is easily handled in the full electrode slurry preparation.

The very high aspect ratio for SWNT (approximately 1000×) and CNF (approximately 100×) fibers leads to a “jammed” network at low solids. The “jammed” volume fraction (ϕ) is approximated from the aspect ratio (α) as ϕ*α˜5 which predicts the CNF gel to form at 5% v/v (or 10% w/w in NMP) and the SW-CNT at 0.5% v/v (or 1% w/w in NMP). Here, these gels are aged for 1-week to observe syneresis (e.g., expulsion of solvent from the compacting gel network). The gel syneresis is measured as being avoided at 5.0% w/w (SW-CNT) and 12.0% w/w (CNF) in NMP, which provides in certain variations, optimized solids content for these two stock carbon dispersions.

### Example 3

In another variation, two examples of electrode slurry prepared in accordance with certain aspects of the present disclosure are formulated with components detailed in Table 3. These components include an electrode conductive filler precursor formed as described above and containing 15.0% graphene nanoparticles, 18 wt. % of (20 wt. % solution of PVPy in NMP) amounting to 3.6 wt. % of PVPy stabilizing polymer, and 81.4 wt. % of NMP. The precursor dispersion was then milled in the Thinky ARE-310™ mixer for 25 minutes at 2,000 rpm which reached a 53° C. temperature due to viscous heating.

The electroactive material is a negative electroactive material in the form of silicon. The electrode slurry was formed by using ZrO₂ mixing beads and using multiple mixing durations at 2,000 rpm as respective components were added, for example, first additional NMP was added and mixed, followed by polyimide binder that was added and mixed, followed by additional introduction of polyimide binder that is then mixed. The electrode slurry was then coated on copper foil with a doctor blade and dried overnight in vacuum at 50° C.

TABLE 3

| | | |
|---|---|---|
| Component | Slurry #1 (g) | Slurry #2 (g) |

| Master 15% GNP dispersion | 0.335 | | 0.334 | |
|---|---|---|---|---|
| Silicon particles | 0.396 | | 0.409 | |
| ZrO₂ mixing beads | 6 | | 6 | |
| Mix Time @ 2000 rpm | 15 | minutes | 15 | minutes |
| NMP | 0.201 | | 0.191 | |
| Mix Time @ 2000 rpm | 15 | minutes | 15 | minutes |
| Polyimide binder | 0.088 | | 0.123 | |
| Mix Time @ 2000 rpm | 10 | mins | 10 | mins |
| Polyimide binder | 0.104 | | 0.147 | |
| Mix Time @ 2000 rpm | 10 | mins | 10 | mins |

| | | |
|---|---|---|
| Solids Content | 44.3% | 43.7% |
| Ratios (Si/GNP/PI/PVPy) | 80/10/8/2 | 78/10/10/2 |

Thus, in various aspects, the present disclosure contemplates processes to prepare electrodes with stock carbon dispersions at high solids with minimal agglomerate yield. A product formulation includes an adsorbing stabilizing polymer provides for colloidal stability and safer handing. It should be noted that electrodes prepared in accordance with the present disclosure using the electrode conductive filler precursor dispersion require fewer addition steps to form a full electrode assembly than a comparative electrode where dry carbon powders are added instead, thus making it possible for more rapid electrode slurry fabrication.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode conductive filler precursor dispersion comprising:
a conductive carbon-based particle selected from the group consisting of: graphene nanoplatelet (GNP), carbon nanofibers (CNF), carbon nanotubes (CNT), or combinations thereof;
a stabilizing polymer comprising polyvinyl-4-pyridine (PVPy); and
a solvent, wherein the electrode conductive filler precursor dispersion is substantially free of syneresis for greater than or equal to about 7 days.

2. The electrode conductive filler precursor dispersion of claim 1, wherein the solvent comprises N-methyl-2-pyrrolidone (NMP).

3. The electrode conductive filler precursor dispersion of claim 1, wherein the conductive carbon-based particle is present at greater than or equal to about 1 weight % to less than or equal to about 15 weight % of the electrode conductive filler precursor dispersion.

4. The electrode conductive filler precursor dispersion of claim 1, wherein the conductive carbon-based particle comprises:
graphene nanoplatelet (GNP) at greater than or equal to about 1 weight % to less than or equal to about 15% weight % of the electrode conductive filler precursor dispersion;
carbon nanofibers (CNF) at greater than or equal to about 1 weight % to less than or equal to about 12% weight % of the electrode conductive filler precursor dispersion; or
carbon nanotubes (CNT) at greater than or equal to about 1 weight % to less than or equal to about 5% weight % of the electrode conductive filler precursor dispersion.

5. The electrode conductive filler precursor dispersion of claim 1, comprising the conductive carbon-based particle at greater than or equal to about 3 weight % to less than or equal to about 20 weight % of the electrode conductive filler precursor dispersion, the solvent at greater than or equal to about 70 weight % to less than or equal to about 97 weight % of the electrode conductive filler precursor dispersion, and the stabilizing polymer at greater than or equal to about 1 weight % to less than or equal to about 8 weight % of the electrode conductive filler precursor dispersion.

6. The electrode conductive filler precursor dispersion of claim 1, wherein the stabilizing polymer is present at greater than or equal to about 3 mg/m² to less than or equal to about 5 mg/m² loading relative to a surface area of the conductive carbon-based particle.

7. The electrode conductive filler precursor dispersion of claim 1, wherein the stabilizing polymer is present at greater than or equal to about 3 weight % to less than or equal to about 5 weight % of the electrode conductive filler precursor dispersion.

8. The electrode conductive filler precursor dispersion of claim 1, wherein the electrode precursor dispersion is shelf stable for greater than or equal to about 30 days.

9. A method of making an electrode conductive filler precursor dispersion comprising:
mixing conductive carbon-based particles in a liquid at a shear rate for debundling, wherein the conductive carbon-based particles are selected from the group consisting of: graphene nanoplatelet (GNP), carbon nanofibers (CNF), carbon nanotubes (CNT), and combinations thereof; and
introducing a stabilizing polymer comprising polyvinyl-4-pyridine (PVPy) and a solvent into the conductive carbon-based particles to form the electrode conductive filler precursor that is substantially free of syneresis for greater than or equal to about 7 days.

10. The method of claim 9, wherein a solids content during the mixing is greater than or equal to about 20 weight % solids to less than or equal to about 60 weight % solids.

11. The method of claim 9, wherein the mixing is substantially free of grinding or milling media.

12. The method of claim 9, wherein the stabilizing polymer is added at greater than or equal to about 3 mg/m² to less than or equal to about 5 mg/m² loading relative to a surface area of the conductive carbon-based particle to suppress reagglomeration.

13. The method of claim 9, wherein the stabilizing polymer is present at greater than or equal to about 1 weight % to less than or equal to about 8 weight % of the electrode conductive filler precursor dispersion.

14. The method of claim 9, wherein the conductive carbon-based particles comprises:
graphene nanoplatelet (GNP) at greater than or equal to about 1 weight % to less than or equal to about 15% weight % of the electrode conductive filler precursor dispersion;
carbon nanofibers (CNF) at greater than or equal to about 1 weight % to less than or equal to about 12% weight % of the electrode conductive filler precursor dispersion; or
carbon nanotubes (CNT) at greater than or equal to about 1 weight % to less than or equal to about 5% weight % of the electrode conductive filler precursor dispersion.

15. A method of making an electrode comprising:
mixing an electrode conductive filler precursor dispersion with a binder and electroactive material particles to form a slurry, wherein the electrode conductive filler precursor dispersion comprises a conductive carbon-based particle selected from the group consisting of: graphene nanoplatelet (GNP), carbon nanofibers (CNF), carbon nanotubes (CNT), and combinations thereof, a stabilizing polymer comprising polyvinyl-4-pyridine (PVPy), and a solvent;
applying the slurry to a current collector; and
drying the slurry to form an electrode active layer disposed on the current collector.

16. The method of claim 15, further comprising consolidating the electrode active layer and current collector.

17. The method of claim 15, wherein a dried electrode active layer comprises greater than or equal to about 0.1 weight % to less than or equal to about 15 weight % of the conductive carbon-based particle, greater than or equal to about 50 weight % to less than or equal to about 99 weight % of the electroactive material particles, and greater than or equal to about 0.5 weight % to less than or equal to about 15 weight % of a total amount of polymer including the binder and stabilizing polymer.

18. The method of claim 15, wherein the electroactive material particles comprise silicon.

19. The method of claim 15, wherein the conductive carbon-based particle is evenly distributed in the electrode.

20. The method of claim 15, wherein the slurry comprises the conductive carbon-based particle at greater than or equal to about 5 weight % to less than or equal to about 25 weight %, the electroactive material particles at greater than or equal to about 50 weight % to less than or equal to about 80 weight %, the solvent at greater than or equal to about 1 weight % to less than or equal to about 5 weight %, and a total amount of binder and stabilizing polymer at greater than or equal to about 5 weight % to less than or equal to about 15 weight %.
